(19) United States
(12) Patent Application Publication
(10) Pub. No.: US 2006/0013610 A1
(43) Pub. Date: Jan. 19, 2006

(54) Machine user interface including a pop up menu feature

(75) Inventors: Andrew T. Martin, Honeoye Falls, NY (US); Shane Jewitt, Rochester, NY (US); Karen Totten, Macedon, NY (US); Marc J. Krolczyk, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/893,681

(22) Filed: Jul. 16, 2004

(51) Int. Cl. G03G 15/00

(52) U.S. Cl. 399/81

(57) ABSTRACT

A touch-based machine User interface (UI) includes (a) a UI work area; (b) bar regions for displaying menu headings; (c) a selectable object table displayable within the UI work area; (d) a series of regions within the selectable object table, each region of the series of regions containing a selectable object; and (e) an invokable pop menu for controlling each selectable object within the series of regions, the pop up menu including selectable control activities that are functions of each selectable object within the series of regions, and the pop up menu normally is hidden, thereby increasing and allowing for efficiently utilizing the UI work area.

### RELATED APPLICATIONS

This application is a utility version of Applicant's design patent application U.S. Ser. No. ______ filed ______ [Applicant's Docket No. DS/A3339].

The present disclosure is directed to machine user interfaces (UI's), and more specifically, to a touch-based machine user interface having selectable pop up menus.

One example of a conventional reprographic machine is the office copier. Traditionally, the copier, in the office equipment context, refers to a light lens xerographic copier in that paper originals are in fact photographed. The images are focused on an area of a photoreceptor that is subsequently developed with toner. The developed image on the photoreceptor is then transferred to a copy sheet that in turn is used to create a permanent copy of the original.

In recent years, however, there has been made available what is known as digital copiers or printing machines. In the most basic functions, a digital copier or printing machine performs the same functions as a light lens copier, except that includes a programmable controller for controlling its functions, and the original image to be copied is not directly focused on a photoreceptor. Instead, with a digital copier or printer, the original image is received, for example, from a personal computer (PC) work station, or storage media, or is scanned by a device generally known as a raster input scanner (RIS) that is typically in the form of a linear array of small photosensors. The controller further enables a wide range of image manipulation and processing capabilities.

The original image received as such is focused on the photosensors in the RIS. The photosensors convert the various light and dark areas of the original image to a set of digital signals. These digital signals are temporarily retained in a memory and then eventually are further processed, and manipulated/and or used as is, with the aid of a user interface (UI) assembly, to operate the digital printing machine or copier when it is desired to print copies of the original. The digital signals may also be sent directly to the digital printing machine or copier without being stored in a memory. Typically however, each such digital printing machine or copier includes a user interface (UI) having an array of features.

User interfaces (UI's) on such digital printing machines or copiers typically utilize LCD's or full screen displays with graphics that include selectable objects in the form of buttons, icons, tabs, and file folders for example. In designing such UI's, it is known for example to provide dedicated space within a UI dialog window or display area for presenting “right click” or automatic, some times unneeded help content. When presented in a separate window the focus switches between the original application and the help window as the user toggles between them. Drop down menus are of course also known but typically a drop down menu issues from a specific tool bar menu item e.g. File, Edit, View, etc. whose sole purpose is to invoke the drop down menu. In mouse-clicking operations, similar pop up menus are available by a “right mouse click” for example within the context of PC applications. This however is not the case with touch-based user interfaces where dedicated command buttons are instead the norm.

Currently operations on items in a display area table within the context of a touch screen display or a touch-based UI typically require dedicated command buttons that occupy dedicated display space on the UI. This display space is often at a premium especially on constrained applications such as half panel displays. Adding a dedicated area for command buttons as such in the display area usually decreases the number of table rows that can be displayed within the UI display area.

In accordance with the present disclosure, there is provided a touch-based machine User interface (UI) includes (a) a UI work area; (b) bar regions for displaying menu headings; (c) a selectable object table displayable within the UI work area; (d) a series of regions within the selectable object table, each region of the series of regions containing a selectable object; and (e) an invokable pop menu for controlling each selectable object within the series of regions, the pop up menu including selectable control activities that are functions of each selectable object within the series of regions. The pop up menu as such normally is hidden, thereby increasing and allowing for efficiently utilizing the UI work area.

The following is a brief description of the drawings used to describe the present disclosure, and thus, these drawings are being presented for illustrative purposes only and thus should not limit the scope of the present disclosure, wherein:

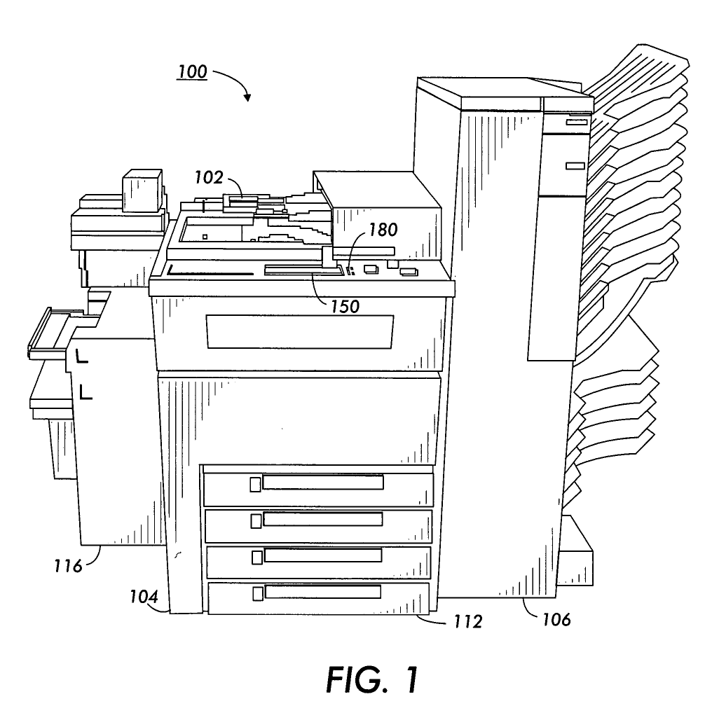

FIG. 1 is an illustration of a reprographic machine including the touch-based UI in accordance with the present disclosure;

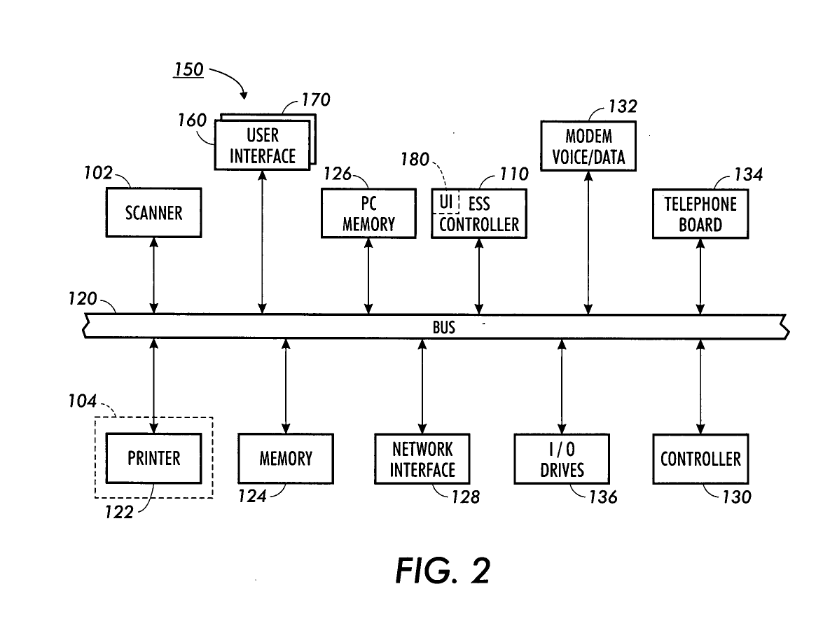

FIG. 2 is a block diagram illustration of the reprographic machine of FIG. 1;

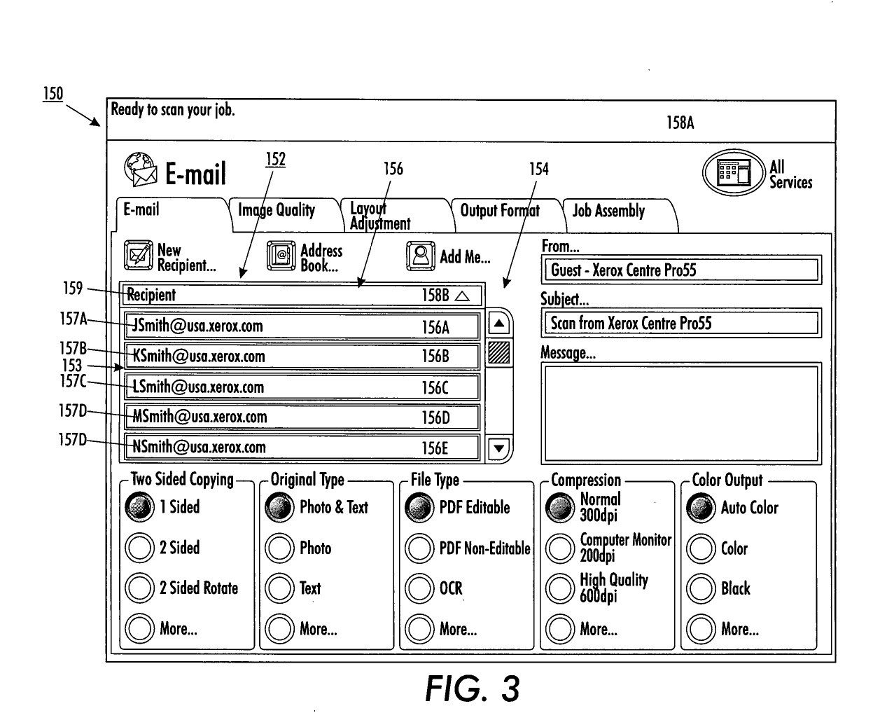

FIG. 3 is a plan view illustration of the touch-based UI of the present disclosure showing a selectable object table; and

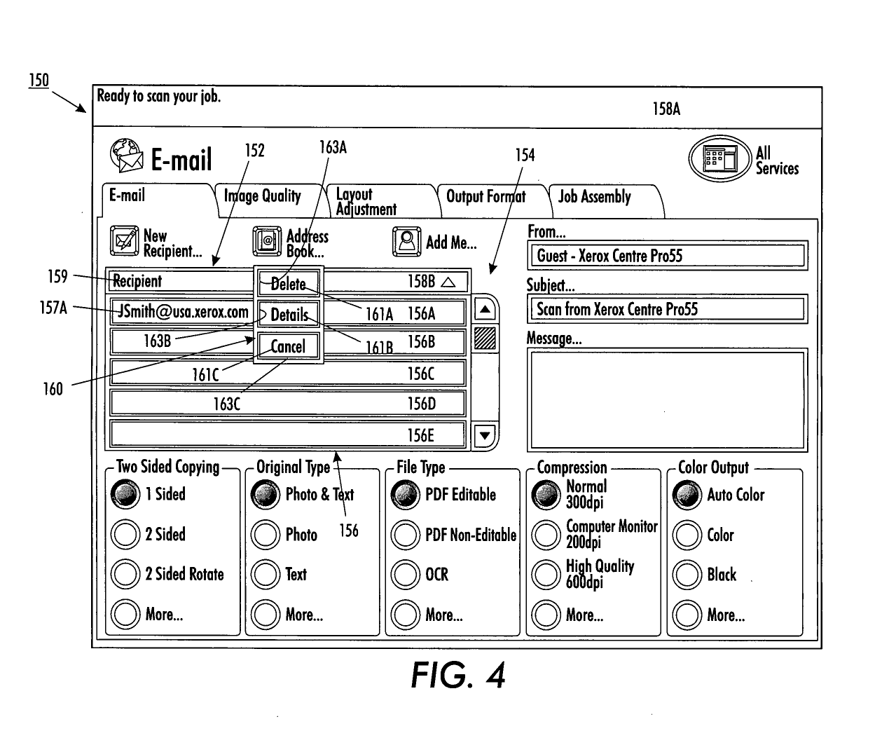

FIG. 4 is plan view illustration of the touch-based UI of the present disclosure showing a selectable object table and an invoked pop up menu in accordance with the present disclosure.

### DETAILED DESCRIPTION

The following is a detailed description of the present disclosure. In this description, the drawings have been utilized to illustrate the concepts of the present disclosure. In this description as well as in the drawings, like reference numerals indicate the same items or equivalent items.

Referring now to FIGS. 1-2, an overall construction, and a block diagram, of a digital reprographic machine 100 including the touch-based UI 150 of the present disclosure, are illustrated. As shown, the digital machine 100 includes a scanning device 102, a printing module 104, and the touch-based UI 150 (to be described in detail below). The digital machine 100 may also include a finisher device 106 that may be a sorter, tower mailbox or stapler, and at least an electronic subsystem (ESS) controller 110 for controlling all the features and functions of the machine 100. The printing module 104 may include a plurality of paper trays 112 that store image carrying media such as paper that is used in the printing process. Lastly, the digital machine may include a high capacity feeder 116 that is capable of holding large amounts of media or paper stock to be used by the machine.

In a typical scanning function, the operator would utilize the scanning device 102 to scan in the images from the original documents. This scanning device 102 may be a platen type scanner or may include a constant velocity transport system that moves the original documents across a stationary scanning device. Moreover, the scanning device 102 may also include a document handling system that is capable of placing the original documents, automatically, on the glass platen for scanning.

With respect to the printing functions, the printing module 104 would retrieve the proper paper from one of the multiple paper trays 112 or the high capacity feeder 116, render the desired image on the retrieved paper, and output the printed image to the finishing device 106 for further operations.

An example of the basic architecture of the digital machine 100 is illustrated as a block diagram in detail in FIG. 2, and includes the scanner 102 that converts an original image into a set of digital signals that can be either stored or reproduced. The scanner 102 is connected to a central bus system 120 that may be either a single bus or a plurality of buses that provide interconnections and intercommunications between the various modules and stations on the digital machine.

The digital machine 100 also includes a digital printing device 122 of the printing module 104 (FIG. 2) that converts digital signals representing an image into a hardcopy of that image on a recording medium whether the recording medium be paper, transparency, or other type of markable medium. A first memory device 124 is provided for storing a variety of types of digital information such as machine fault information, machine history information, digital images to be processed at a later time, instruction sets for the machine or job instruction sets. A second memory device forming an electronic pre-collation memory section 126 may be provided for storing the digital representation of the image being presently rendered by the digital printing device 122. In the electronic pre-collation memory 126, the digital image is already laid out in its page structure so that it can be readily rendered by the digital printing device 122.

Since the digital machine 100 may be connected to a network including a PC work station (not shown), it includes a network interface 128 and an additional controller 130 that control the interrelationship between the various modules or stations on the digital machine 100 and the network.

In cases where the digital machine 100 is a multi-function machine, it would include, typically, a voice/data modem 132 and a telephone circuit board 134. Moreover, the digital machine may also include input/output drives 136 such as a floppy disc drive, a CD ROM drive, a tape drive, or other type of drive that can accept a portable memory device.

Referring now to FIGS. 1-7, the digital machine 100, in accordance with the present disclosure, includes (a) devices 102, 104, 106, 110 for forming a toner image on an image carrying medium, and (b) the touch-based machine User interface (UI) 150. The touch-based machine User interface (UI) 150 as illustrated includes (i) a selectable object table 152 displayable within a UI work area 154; (ii) a series 156 of regions within the selectable object table, each region 156A-E of the series 156 containing a selectable object 157A-E; and (iii) a common invokable pop menu 160 for controlling each selectable object within the series 156 of regions, the pop up menu including selectable control activities 161A-C, that in one embodiment can be common to each selectable object 157A-E, within the series of regions. In another embodiment, the selectable control activities 161A-C may vary from pop up menu to pop up menu as a function of the particular object 157A-E that is selected. In either case, the pop up menu 160 is normally hidden, thereby increasing and allowing for efficiently utilizing the UI work area 154.

The touch-based machine User interface (UI) 150 also includes bar regions 158A, 158B for displaying menu headings 159. In accordance with an aspect of the present disclosure, the pop up menu 160 is easily and directly invokable with a single touch of any of the selectable objects 157A-E within the series of regions 156A-E. The selectable control activities 161A-C of the pop up menu are each connectable to, for controlling, each selectable object 157A-E within the series of regions. The pop up menu 160, when invoked as above, is displayable on top or over at least a portion of the series of regions 156A-E as shown in FIG. 4. The pop up menu 160 after being invoked, is dismissible by selecting a selectable control activity 161A-C within the pop up menu, or by touching any area outside the pop up menu itself.

The selectable control activities 161A-C within the pop up menu 160 are mutually exclusive in their operation on a selected object 157A-E within the series of regions. In accordance with another aspect of the present disclosure, when one selectable object 157A-E within the series of regions is touched to invoke the pop up menu 160, the selectable control activities 161A-C within the pop up menu are only connected to, and only control, the one selectable object 157A-E within the series of regions.

Thus the touch-based machine User interface (UI) 150 in other words can be seen to include (a) the UI work area 154; (b) bar regions 158A, 158B for displaying menu headings 159; (c) a selectable object table 152, such as a selectable address book segment 153 that is displayable within the UI work area; (d) a series 156 of rows 156A-E within the selectable address book segment 153, each row 156A-E of the series of rows containing a selectable address item 157A-E; and (e) an invokable pop menu 160 for controlling each selectable address item 157A-E within the series of rows of the address book segment. The pop up menu 160 as shown includes selectable control activities 161A-C connectable to, and usable to control, the each selectable address item 157A-E within the series of rows of the address book segment. The, pop up menu 160 normally is hidden, thereby increasing and allowing for efficiently utilizing the UI work area. The selectable control activities 161A-C of the pop up menu for example include a “delete” activity, a “cancel” activity, a “details” display activity, and an “edit” activity.

The pop up menu 160, when invoked, is displayable on top or over at least a portion of the series of regions 156A-E. In one embodiment, when one selectable object 157A-E within the series of regions 156A-E is touched to invoke the pop up menu, the selectable control activities 161A-C within the pop up menu are only connected to, and control, that one selectable object 157A-E within the series of regions.

Thus the pop up menu 160 is a UI dialog element that is invoked and displayed over the tale only when a user touches a row or object item in the table. The pop menu as such contains all of the available commands relevant to the selected or touched object item 157A-E on the table. As such, the number and particular or specific control activities 161A-C and related command buttons 163A-C on the pop up menu 160 can vary depending on the object or table item 157A-E touched or selected. In either case, the user then touches the desired command button for a desired control activity 161A-C to execute such activity. The controller 110 responds by automatically dismissing or closing the pop up menu 160 and executing the activity.

In general, the pop up menu 160 may consist of a list box containing a set of mutually exclusive activity menu items, for example, edit, cancel, delete. In the context of a touch-based UI, the pop up menu 160 is invoked when a user touches an object row 156A-E within a table 152 of such selectable items. In one embodiment, the specific contents 161A-C for example, of the pop up menu 160 can vary from selectable object 157A-E to selectable object 157A-E in the table, and hence is a function of the object or state of the object selected.

In operation, after being invoked, the pop up menu 160 will remain open until a user either touches one of the activity items 161A-C in the pop up menu or touches outside the pop up menu, thus dismissing or closing the pop up menu. Once the user touches an activity item in the pop up menu, such activity item is selected for execution, the pop up menu closes, and the selected operation of the activity item is performed. The pop up menu 160 as such is ideal for shortcuts and for use in space-constrained areas.

Each selectable pop-up menu activity item 161A-C has at least three states or conditions, a selectable state, a selected state, and an unselectable state. In the selectable state, each activity item for example appears as a light colored button object that is raised slightly above the “surface” of the surrounding list box or area, and has a text label, in black, displayed on it. When selected or pressed, the colored button of the pop-up menu item then appears recessed into the “surface” of the surrounding area. The text label is then displayed in white on the colored button. When based on the table object selected, a pop up menu item is unselectable, for example because it is not applicable, the colored button of that pop up menu item then appears flat and has the same appearance value as the window background in that it is located, and includes a gray border around it. The text label on it is then displayed in gray.

As can be seen, there has been provided a touch-based machine User interface (UI) includes (a) a UI work area; (b) bar regions for displaying menu headings; (c) a selectable object table displayable within the UI work area; (d) a series of regions within the selectable object table, each region of the series of regions containing a selectable item; and (e) an invokable pop menu for controlling each selectable item within the series of regions, the pop up menu including selectable control activities that are functions of each selectable object within the series of regions, and the pop up menu normally is hidden, thereby increasing and efficiently utilizing the UI work area.

While the present disclosure has been described with reference to various embodiments as described above, it is not confined to the details set forth above, but is intended to cover such modifications, variations or changes as may come within the scope and spirit of the attached claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. 1. A touch-based machine User interface (UI) comprising:
(a) a UI work area;
(b) bar regions for displaying tool titles and menu headings;
(c) a selectable object table displayable within said UI work area;
(d) a series of regions within said selectable object table, each region of said series of regions containing a selectable object; and
(e) an invokable pop menu for controlling each selectable object within said series of regions, said pop up menu including selectable control activities associated with said each selectable object within said series of regions, and said pop up menu normally being hidden, thereby increasing and allowing for efficiently utilizing said UI work area.

2. The touch-based machine User interface (UI) of claim 1, wherein said selectable control activities are a function of said each selectable object within said series of regions.

3. The touch-based machine User interface (UI) of claim 1, wherein said pop up menu is easily and directly invokable with a single touch of any of selectable object within said series of regions.

4. The touch-based machine User interface (UI) of claim 1, wherein said selectable control activities of said pop up menu are each connectable to, for controlling, each selectable object within said series of regions.

5. The touch-based machine User interface (UI) of claim 1, wherein said pop up menu, when invoked, is displayable on top at least a portion of said series of regions.

6. The touch-based machine User interface (UI) of claim 1, wherein said selectable control activities are common to said each selectable object within said series of regions.

7. The touch-based machine User interface (UI) of claim 1, wherein said pop up menu is dismissible by touching any area outside of said pop up menu.

8. The touch-based machine User interface (UI) of claim 1, wherein said pop up menu is dismissible by selecting a selectable control activity within said pop up menu.

9. The touch-based machine User interface (UI) of claim 1, wherein said selectable control activities within said pop up menu are mutually exclusive in their operation on a selected object within said series of regions.

10. The touch-based machine User interface (UI) of claim 1, wherein when one selectable object within said series of regions is touched to invoke said pop up menu, said selectable control activities within said pop up menu are only connected to, and only control, said selectable object within said series of regions.

11. A touch-based machine User interface (UI) comprising:
(a) a UI work area;
(b) bar regions for displaying tool titles and menu headings;
(c) a selectable address book segment displayable within said UI work area;
(d) a series of rows within said selectable address book segment, each row of said series of rows containing a selectable address item; and
(e) an invokable pop menu for controlling each selectable address item within said series of rows of said address book segment, said pop up menu including selectable control activities connectable to, and usable to control, said each selectable address item within said series of rows of said address book segment, and said pop up menu normally being hidden, thereby increasing and allowing for efficiently utilizing said UI work area.

12. The touch-based machine User interface (UI) of claim 11, wherein said selectable control activities of said pop up menu include a “delete” activity.

13. The touch-based machine User interface (UI) of claim 11, wherein said selectable control activities of said pop up menu include a “cancel” activity.

14. The touch-based machine User interface (UI) of claim 11, wherein said selectable control activities of said pop up menu include a “details” display activity.

15. The touch-based machine User interface (UI) of claim 11, wherein said selectable control activities of said pop up menu include an “edit” activity.

16. A touch-based machine User interface (UI) including:
(a) a selectable object table displayable within a UI work area;
(b) a series of regions within said selectable object table, each region of said series of regions containing a selectable object; and
(c) an invokable pop menu for controlling each selectable object within said series of regions, said pop up menu including selectable control activities associated with said each selectable object within said series of regions, and said pop up menu normally being hidden, thereby increasing and allowing for efficiently utilizing said UI work area.

17. The touch-based machine User interface (UI) of claim 16, wherein said pop up menu, when invoked, is displayable on top at least a portion of said series of regions.

18. The touch-based machine User interface (UI) of claim 16, wherein when one selectable object within said series of regions is touched to invoke said pop up menu, said selectable control activities within said pop up menu are only connected to, and only control, said selectable object within said series of regions.

19. A digital image printing machine for producing toner images on image carrying media, the electrostatographic reproduction machine comprising:
(a) means for forming a toner image on image carrying media; and
(b) a touch-based machine User interface (UI) including:
(i) a selectable object table displayable within a UI work area;
(ii) a series of regions within said selectable object table, each region of said series of regions containing a selectable object; and
(iii) an invokable pop menu for controlling each selectable object within said series of regions, said pop up menu including selectable control activities associated with said each selectable object within said series of regions, and said pop up menu normally being hidden, thereby increasing and allowing for efficiently using said UI work area.

20. The digital image printing machine of claim 19, wherein when one selectable object within said series of regions is touched to invoke said pop up menu, said selectable control activities within said pop up menu are only connected to, and only control, said selectable object within said series of regions.
